(19) United States
(12) Patent Application Publication
(10) Pub. No.: US 2009/0043656 A1
(43) Pub. Date: Feb. 12, 2009

(54) Doorism

(75) Inventors: Joachim Guenster, Baldham (DE); Thomas Binzinger, Baldham (DE)

Correspondence Address: AC TECHNOLOGIES, S.A., MAISON 2, LEITHUM, 9910, LU

(73) Assignee: AC Technologies S.A., Leithum (LU)

(21) Appl. No.: 12/185,916

(22) Filed: Aug. 5, 2008

Related U.S. Application Data
(60) Provisional application No. 60/954,324, filed on Aug. 7, 2007.

(51) Int. Cl. G06Q 30/00; G06Q 40/00

(52) U.S. Cl. 705/14; 705/35

(57) ABSTRACT

The present invention relates to a computer-implemented method for electronically managing the admission to locations and events while allowing enhanced advertising of related products and services.

### CROSS-REFERENCE TO RELATED APPLICATIONS

This application claims priority from U.S. Provisional Patent Application Ser. No. 60/954,324, filed on 7 Aug. 2007 and entitled Doorism, the contents of which are hereby fully incorporated by reference.

### BACKGROUND OF THE INVENTION

1. Field of the Invention

The present invention relates generally to web-based services using mobile telecommunication networks.

2. Description of the Related Art

Social networking websites are one of the most popular services of the Internet nowadays. Billion of Internet users worldwide meet in different networks to interact with other users, store data, share interest or activities and so on. In the last years these social networks have expanded through the use of mobile telecommunication networks to offer a wider range of services and applications.

In almost any case, one of the revenue models of social networking websites relates to advertising. Since businesses operate globally, social networks can make it easier to keep in touch with contacts around the world. Therefore, companies use social networks for advertising and selling their products and services.

In a more specialized level, there are also professional networking websites which function as online meeting places for business and industry professionals. In the particular case of event planning, many websites offer resources for venues and vendors to offer their products and services for professional or occasional planners of events.

The present method combines the basic model of professional networks with social networking services and mobile telecommunication networks for electronically managing admission to locations and events while advertising related products and services.

### SUMMARY OF THE INVENTION

The present invention relates to a method for electronic managing admission to a location or event while enhancing customized advertising of related products and services.

### DETAILED DESCRIPTION OF THE INVENTION

The present invention relates to a computer-implemented method for managing the admission to a location or event while enhancing customized advertising services.

The system comprises a social networking website (hereafter: the network) and a mobile application attached thereto. After registration, users log into the network by using a web- or a mobile interface. Storing means of the system allows for saving information that users and providers input to the network. Among others, such information relates to products and services offered by network providers, mobile devices attached to the network and preferences of network users. Processing means of the system generate a token based on this information. Tokens are then sent to mobile devices attached to the network. In this specification the term “token” means a special series of bits that travels around the network. According to the different embodiments of the present invention, tokens may contain information about locations or events, admission passes and advertisement.

Programming means of the system differentiate between “members” and “users” in relation to the services provided to each of them. To become a member, the applicant is requested to provide personal information, pay a subscription fee and fulfill certain conditions imposed by network providers. On the contrary, users only create a profile in order to have access to the network but services are restricted to receive information about locations or events and participate in different promotions. In this specification, members and users are often referred as to “network users” to indicate that a specific application of the method is available to both of them. The term “network provider” (or provider) refers to any individual or organization using the system to advertise a location or event and manage admission thereto. Network providers may also use the system to advertise related products and services as well as third parties brands, products or services.

In a first embodiment, the system provides members with an electronic admission pass. First, members receive the provider information in their mobile devices and decide on the event or location. Upon request to the system via SMS, email or any other means of electronic communication, the system sends a token containing the admission pass to the mobile device of the requester. This admission pass allows the entrance to the specific event or location. Depending on its content, the admission pass may also indicate special treatment for the member. The term “special treatment” refers, without being limited to, immediate admission into the provider location or event, ballet parking, access to VIP zones and preference for table reservations.

The system continuously updates the list of the admission passes it generates and sends the updated list to the doorman's mobile device on predetermined time intervals. In this way, the doorman possesses the information of the members who are approaching the location or event. Members keep the token as receipt confirmation. Alternatively, the provider may download the list from the website by login into the network at any time.

Generally, tokens are created automatically by the system. Nonetheless, network providers may be able to determine certain token characteristics or features. Among others, they may determine whether a token should consist of text only or text combined with images, whether such images should be static or videos, and whether text and images should be changed within a specific period of time. They may also determine the number of retransmissions allowed for a token.

Depending on the kind of membership, members are allowed to forward the token containing the admission pass to mobile devices non-attached to the network. In this way, members are able to invite friends outside the network to the provider location or event. The number of times that the admission pass might be forwarded is determined by various factors, including but not limited to, kind of membership, actual public affluence in the provider's location, etc.

Network providers may also provide users with information about locations and events within a specific geographic area by sending a token. In this way, network providers are able to advertise their locations and events as well as special promotions or discounts to non-members according to their specific advertising or marketing objectives.

The system may also generate tokens containing questions to the users. Users answer the question via a SMS payment service or any other similar electronic payment system. If the answer is right, users receive a token that may contain a discount or any other similar promotion directed to attract public including, but not limited to, welcome drinks, free wardrobe and parking lot, etc.

A further application of the method relates to the redirection function. In those cases in which a location is crowed to full capacity, the system informs network users that entry might be denied or delayed and redirects them to the nearest location or similar event available. Network users predefine the criteria under which they are redirected. These criteria may refer, without being limited to, area of the city, kind of location (bar, discotheque, lounge, after) and kind of music (jazz, techno, hip hop, latin).

Programming means of the system allows for connecting to a route planer to provide network users with a map showing the route to the location or event. The route planer is provided upon request by sending a message to the system containing the requester actual situation. In one further embodiment, the system may also implement a Location Based System (LBS) to automatically determine the requester's situation. Subsequently, the system sends a route plan delivered according to the criteria predefined by the network user as described in the paragraph above. The cost of the route plan depends on whether the requester is a member or a user of the network. To illustrate the latest, a member might probably have this service included within its service package while a user could be charged by an SMS payment service.

The system also allows members to localize other members. In this application, members create a private network inside the network and authorize its members to receive their location information. By way of example only, member “A” authorizes member “B” to receive its location information. Member B sends a localization request of A to the system. The system then sends B the last token received by A from the system. This is useful when members are inside provider's location or event and i.e. mobiles devices are not able to receive the carrier signal.

Third parties may also use the system to obtain revenues by closing marketing agreements with network providers. In this given application, company “A” closes an agreement with network provider “B”. The system issues a token containing a riddle regarding “A” product or service. The user sends the answer to the system and receives in return an admission pass to the provider location or event if the answer is right. The token containing the question can be forwarded to mobile devices non-attached to the network. Thereby, company “A” is able to send tokens not only to users of the network but also to any other person willing to send the answer in order to receive the admission pass to a location or event.

Third parties may also access the network to offer electronic ads to network providers. Electronic ads are stored on the network where providers are able to choose between them. In this embodiment, the third party has an interest that its electronic ad is integrated into the network provider token. Therefore, the third party makes an offer comprising an specific amount to be paid for such integration. These offers are presented to network providers in an online auction in the form of bids. Third parties are able to see other's bids and increase the amount offered in order to win the auction. Thereby, network providers are able to obtain the highest payment for attaching a specific electronic ad to their tokens. Network providers, third parties and members create an account, which is linked to a bank account or credit card in order to automatically perform all payments and track any active and passive movements detected by the system. The system also allows to print invoices, view pre-orders, change payment method, combine orders, etc. Network providers also receive a percentage of the revenues coming from membership payments.

It is intended that the foregoing detailed description be understood as an illustration of selected forms that the invention can take and not as a definition of the invention. It should be remarked that the system functioning is described in order to adequate disclose how the steps of the method are implemented. Nevertheless, it is only the following claims, including all equivalents, which are intended to define the scope of this invention.

What is claimed is:

1. A method for managing admission to a location or event, the method comprising the steps of:
(a) creating a web-based social network, said social network containing information on locations and events within a geographic area; said information being input by providers located within such geographic area;
(b) registering members to the social network website;
(c) storing preferences of the members;
(d) attaching a mobile application to the social network, said mobile application allowing access to the network through mobile devices;
(e) associating at least one mobile device for each member, said mobile device being able to store and execute said mobile application;
(f) processing said provider information according to said preferences of the members;
(g) generating at least one token based on said processed information;
(h) sending the said at least one token to the said at least one mobile device associated to the member;
(i) processing the request of a member to obtain an admission pass to a location or event;
(j) providing members with a token containing an admission pass to said location or event;
(k) connecting to a route planner to provide a route map to the destiny location or event, said route map being displayed on the mobile device of the member;
(l) allowing members to localize other members, said members being authorized by each other to request localization information to the network; and
(m) integrating at least one electronic payment system to the network.

2. The method according to claim 1, wherein electronic admission passes are also sent to users, said electronic admission being programmed to request electronic payment of an activation fee upon request of the network provider.

3. The method according to claim 1, wherein (g) and (j) further include advertising content relating to additional products and services of the provider, wherein said advertising content may be changed in predetermined intervals of time according to the provider preferences.

4. The method according to claim 1, wherein said electronic admission token is programmed to allow its further retransmission to at least one mobile device non-attached to the network, said electronic admission pass being programmed to request electronic payment of an activation fee upon request of the network provider.

5. The method according to claim 1, further including a list of the by the network generated admission passes to the location, said list being automatically sent to the provider in predetermined intervals of time.

6. The method according to claim 1, wherein the system automatically redirects members to other locations or events by issuing a token, said token being generated according to preferences of the members.

7. The method according to claim 1, wherein the system implements a locator system that automatically determines the situation of the member requesting the route map.

8. The method according to claim 1, wherein third parties submit different advertisement options to the network providers, said options being organized in the form of bids in an online auction in the social networking website, wherein third parties are allowed to see other third parties bids and increase their owns during the auction.
